(19) United States
(12) Patent Application Publication
(10) Pub. No.: US 2024/0233421 A1
(43) Pub. Date: Jul. 11, 2024

(54) LOGOS THAT FUNCTION AS QR CODES

(71) Applicant: Mitchell Hamlin, Holley, NY (US)

(72) Inventor: Mitchell Hamlin, Holley, NY (US)

(21) Appl. No.: 18/423,482

(22) Filed: Jan. 26, 2024

Related U.S. Application Data
(60) Provisional application No. 63/478,551, filed on Jan. 5, 2023.

(51) Int. Cl. G06V 30/10; G06F 16/53

(52) U.S. Cl. CPC G06V 30/10; G06F 16/53; G06V 2201/09

(57) ABSTRACT

The subject matter relates to a system that allows for information about logos, brands, and trademarks to be accessed more quickly and to function as QR codes. After a company has registered with the present subject matter, these logos would then be scannable and able to link to relevant business information, profiles, and current promotions.

### RELATED APPLICATIONS

This application claims priority to provisional application U.S. 63/478,551 filed on Jan. 27, 2023, and is incorporated in its entirety.

### BACKGROUND OF THE INVENTION

QR Codes and Google Lens come the closest to the present subject matter. However, neither of them currently recognize logos, especially that of small businesses, in the same manner as the present subject matter.

The present subject matter is a powerful new marketing tool for businesses and brands. The present subject matter effectively turns logos and trademarks into rich QR codes, putting a wealth of information at one's fingertips. The present subject matter uses a business' existing logo as their own unique marker for consumers to find the company information more efficiently.

### SUMMARY OF THE INVENTION

The present subject matter effectively turns logos, brands, and trademarks into rich QR codes, putting a wealth of information at one's fingertips.

The present subject matter's platform was designed to make finding business information more accessible and efficient than ever before. Businesses and brands can simply sign up on the platform, register a logo, trademark, or brand and create a business profile. The business profile can have the business's contact information, website links, social media channel links, promotions, discounts, and other content.

Consumers can then simply scan or snap a photo of logos set up with the present subject matter's platform using their mobile device and instantly be redirected to the business profile and the relevant information within it.

The present subject matter is software designed to make finding a business' information easier, faster, and more efficient. A company's logo functions as a universal and virtual business card.

Once registered, the present subject matter will analyze and recognize the logo as a unique “code”. A consumer or potential customer may simply scan a logo, and they will be taken to the company's business profile.

Much like a Google Search but the company's landing page will be an aesthetically pleasing profile-style page to show relevant information. Such as business hours, contact info, direct links to websites, social media accounts, as well as any promotions that the business may be offering. This occurs all in a central location with the scan of a logo.

An example of its use can be described by the following. Say a consumer is shopping and sees a product he/she might want, the consumer can use the present subject matter's software to scan the logo of the brand and find their other products, coupons, discount codes, website, social media accounts, current social events the company is backing, etc. (The company can even offer promotions-Let say you scan a box of Cereal, the company profile can display “If you buy this product, you can get our other product half price”—Etc. . . . )

The present subject matter operates by using the camera function on a cell phone or mobile device, a user may situate the camera frame over a business' logo; The present subject matter's software will use a bitmap tracing technology, similar to that of “facial recognition” software, then match it to the logos registered in the present subject matter's database.

The screen will then display a link to the company's business profile.

The user will be brought to an aesthetically pleasing “Landing Page” that displays the company's social media links, contact information, new product releases, promotions, social event support, locations, menus, etc.

The user would be able to conveniently see all the company's information with an easy scan of a logo.

Some of the benefits for a company to use the present matter are as described. Business owners often put a lot of thought and time developing their logo design. Business logos are normally the first thing a consumer will see and remember. So it makes financial sense that a logo would be the window to the company.

The present subject matter provides ease of access to the company's business information.

It creates a new way for consumers to interact with a business before purchasing. The present subject matter provides a new way to market and advertise products and creates a new route for the business to funnel purchases.

A company does not have to change their current logo.

Business owners would not have to carry business cards. Customers can snap a photo of your logo on your shirt, vehicle, product packaging, sticker, etc.

Influencers can create their own personal branding logo (or use an existing) so their social media and its content can be easily accessed.

Influences can make their unique logo into vinyl stickers for the vehicles, social media pages, etc.

The present subject matter would potentially create a new fun way for business to compete for more aesthetically pleasing and unique logos to draw consumers

Some of the benefits for a consumer to use the present matter are as described. It allows for ease of obtaining a business' information and great deals on products you're already going to buy.

The present subject matter helps consumers find all of the other products that company may offer and provides a fun way to interact when purchasing through a business you've never used or is already a favorite.

When a consumer sees a logo on a company vehicle, shirt, sticker, label, etc.—the consumer doesn't have to approach the person or vehicle, the consumer can simply scan the logo and pull up their profile.

Society is constantly gravitating towards ease of access now that there is ubiquitous cell phone access. Consumers would no longer have to “Google” a product that is right in front of them to see more of what they offer.

All businesses would have to verify proper ownership of the logo to verify that trademark laws are respected.

### BRIEF DESCRIPTION OF DRAWINGS

FIG. 1 illustrates a card of a business's logo, i.e. Hamlin, welding and fabricating LLC with the company's email address HAMLINWELDING.COM. So anyone who set their camera on this logo would get the products or services of the company, special offers, current events, etc., whatever that particular company had set up on the website via the logo.

### DETAILED DESCRIPTION OF THE INVENTION

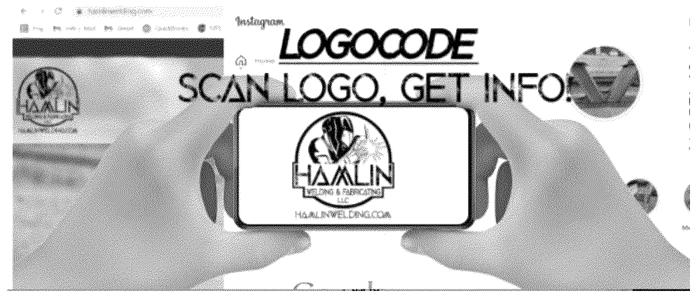

FIG. 1 shows the company's logo on a card, and if a person scans this logo and the company ahead of time had loaded all of the company's products, the company's social media links, contact information, new product releases, promotions, social event support, locations, menus on to this software program page, then all of the information on a company would be pulled up instantly, without the person searching for any of this information separately. When a consumer sees a logo on a company vehicle, shirt, sticker, label, etc. The consumer doesn't have to approach the person or vehicle, the consumer can simply scan the logo and pull up the company's profile.

Company owners often put a lot of thought and time developing their logo design. Company logos are normally the first thing a consumer will see and remember. So it makes financial sense that a logo would be the window to the company; this software program will allow all the company's information dissemination instantly. To use the software program, a company does not have to change their current logo. This software program operates by using the camera function on a cell phone or mobile device, a user may situate the camera frame over a business' logo and the software will use a bitmap tracing technology, similar to that of “facial recognition” software, then match it to the logos registered in the present software program's database, and then all the information of the company is disseminated instantly.

All businesses would have to verify proper ownership of the logo to verify that trademark laws are respected.

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

1. I claim a software program that when a user scans a company's logo, the software will use a bitmap tracing technology, then match it to the logos registered in the software program's database, retrieving a company's information more completely, faster, and more efficiently.

2. The software program of claim 1, wherein said user reads a company logo on a company vehicle, shirt, sticker or label.

3. The software program of claim 1, wherein all company's would have to verify proper ownership of the logo to verify that trademark laws are respected.

4. The software program of claim 2, wherein user doesn't have to approach the person or vehicle, the consumer can simply scan the logo and pull up that company's profile.

5. The software program of claim 1, wherein a user is shopping and sees a product he/she might want, said user can scan the logo of the brand, using said software find the company's other products, coupons, discount codes, website, social media accounts, current social events the company is backing.

6. The software program of claim 1, wherein said software program would potentially create a new fun way for companies to compete for more aesthetically pleasing and unique logos to draw more consumers.
